(19) United States
(12) Patent Application Publication
(10) Pub. No.: US 2026/0208265 A1
(43) Pub. Date: Jul. 23, 2026

(54) ADDITIVE MANUFACTURING DEVICE AND ADDITIVE MANUFACTURING METHOD

(71) Applicant: MITSUBISHI HEAVY INDUSTRIES, LTD., Tokyo (JP)

(72) Inventor: Ryuichi NARITA, Tokyo (JP)

(73) Assignee: MITSUBISHI HEAVY INDUSTRIES, LTD., Tokyo (JP)

(21) Appl. No.: 19/143,176

(22) PCT Filed: Aug. 31, 2023
(86) PCT No.: PCT/JP2023/031966

§ 371 Date: Jun. 25, 2025

(30) Foreign Application Priority Data
Jan. 25, 2023 (JP) 2023-009436

(51) Int. Cl. B22F 10/36; B22F 10/28; B22F 10/85; B22F 12/41; B22F 12/45; B28B 1/00; B28B 17/00; B33Y 10/00; B33Y 30/00; B33Y 50/02

(52) U.S. Cl. CPC B22F 10/36; B22F 10/28; B22F 10/85; B22F 12/41; B22F 12/45; B28B 1/001; B28B 17/0081; B33Y 10/00; B33Y 30/00; B33Y 50/02; B22F 2999/00

(57) ABSTRACT

This additive manufacturing device produces a molded object by laminate molding which involves: supplying a powder material to a build surface of an object to be molded; and fusing and hardening the supplied powder material through irradiating the powder material with a laser. The additive manufacturing device comprises: a main part having a stage on which the molded object is supported; a laser oscillation unit which generates a laser; an irradiation unit which irradiates the build surface with a laser and which is capable of varying the irradiation angle of the laser with respect to the build surface; and an output adjustment unit which is capable of adjusting the laser output on the basis of the area of laser irradiation on the build surface.

### TECHNICAL FIELD

The present disclosure relates to an additive manufacturing device and an additive manufacturing method.

Priority is claimed on Japanese Patent Application No. 2023-009436, filed Jan. 25, 2023, the content of which is incorporated herein by reference.

### BACKGROUND ART

In recent years, a technique called three-dimensional laminate molding, which obtains a molded article by repeatedly performing a step of irradiating metal particles or the like with a laser to melt and cure the metal particles or the like over a plurality of layers, has been put into practical use. In a device using this type of technique, a laser emitted from at least one irradiation point traces a predetermined path while an irradiation angle of the laser is changed from moment to moment using an optical device such as a galvano scanner. As a result, a molded article is constructed.

Here, a device disclosed in PTL 1 to be described below is known as an example of a processing device using a laser. In the device disclosed in PTL 1 to be described below, it is said that the change rate of the amount of heat input to a workpiece by a laser can be adjusted according to the irradiation angle of the laser with respect to an end portion of a welded portion in a case where laser welding is performed.

### CITATION LIST

### Patent Literature

[PTL 1] Japanese Unexamined Patent Application Publication No. 2008-779

### SUMMARY OF INVENTION

### Technical Problem

However, in a case where three-dimensional laminate molding is performed, the amount of heat input to not only an end portion of the path to be scanned with the laser but also the entire path affects the quality of the molded article. For this reason, there has been an increasing demand for a technique capable of maintaining appropriate energy density over the entire path that is scanned with the laser.

The present disclosure has been made to solve the above-described problem, and an object of the present disclosure is to provide an additive manufacturing device and an additive manufacturing method in which the energy density of a laser with which a molded article is irradiated can be appropriately maintained.

### Solution to Problem

In order to solve the above-described problem, an additive manufacturing device according to an aspect of the present disclosure is an additive manufacturing device that supplies a powder material to a build surface of a molded article and performs laminate molding of the molded article by irradiating the supplied powder material with a laser to melt and cure the powder material. The additive manufacturing device includes a main part that includes a stage supporting the molded article, a laser oscillation unit that generates the laser, an irradiation unit that is capable of irradiating the build surface with the laser and changing an irradiation angle of the laser with respect to the build surface, and an output adjustment unit that is capable of adjusting an output of the laser based on an irradiation area of the laser on the build surface.

An additive manufacturing method according to another aspect of the present disclosure is an additive manufacturing method of generating a molded article by irradiating a powder material with a laser to melt and cure the powder material. The method includes a step of generating the laser, a step of irradiating a build surface on which the powder material is laid with the laser and changing an irradiation angle of the laser with respect to the build surface, a step of acquiring an irradiation area of the laser on the build surface, and a step of adjusting energy density of the laser based on the irradiation area.

### Advantageous Effects of Invention

According to the present disclosure, it is possible to provide an additive manufacturing device and an additive manufacturing method in which the energy density of a laser with which a molded article is irradiated can be appropriately maintained.

### BRIEF DESCRIPTION OF DRAWINGS

FIG. 1 is a schematic diagram showing a configuration of an additive manufacturing device according to a first embodiment of the present disclosure.

FIG. 2 is a diagram showing a state of a build surface in a case where the build surface is irradiated with a laser.

FIG. 3 is a functional block diagram showing a configuration of a controller according to the first embodiment of the present disclosure.

FIG. 4 is a schematic diagram showing states of sections set by an output adjustment unit according to the first embodiment of the present disclosure.

FIG. 5 is a flowchart showing each step of an additive manufacturing method according to the first embodiment of the present disclosure and a control flow of the controller.

FIG. 6 is a diagram showing a relationship between a measurement surface and a beam diameter in a case where the measurement surface is irradiated with a laser.

FIG. 7 is a flowchart showing each step of an additive manufacturing method according to a second embodiment of the present disclosure and a control flow of a controller.

FIG. 8 is a schematic diagram showing sections set by an output adjustment unit according to a first modification example common to the respective embodiments of the present disclosure.

FIG. 9 is a schematic diagram showing sections set by an output adjustment unit according to a second modification example common to the respective embodiments of the present disclosure.

FIG. 10 is a hardware configuration diagram of the controller according to each embodiment of the present disclosure.

### DESCRIPTION OF EMBODIMENTS

### First Embodiment

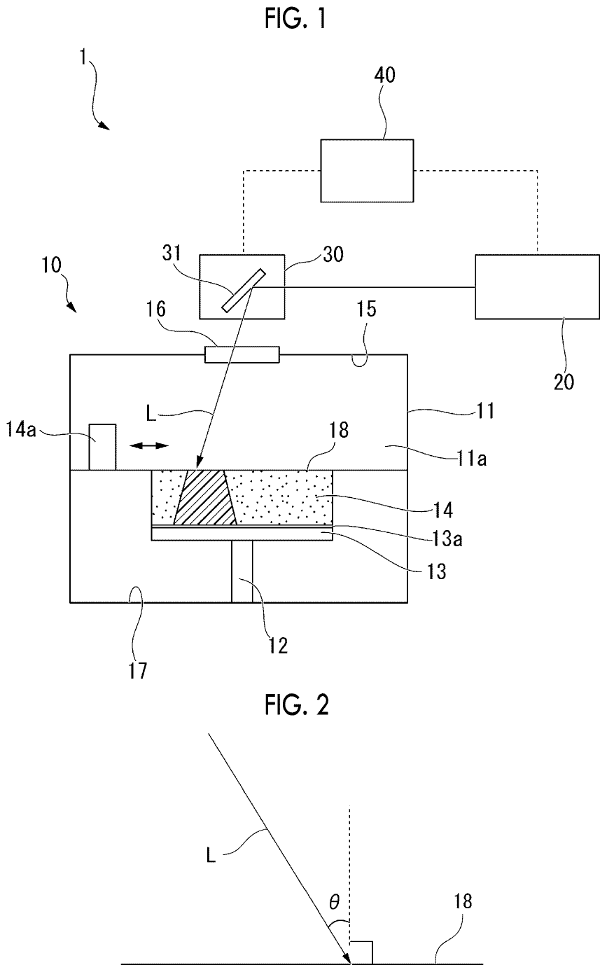

Hereinafter, an additive manufacturing device 1 and an additive manufacturing method according to a first embodiment of the present disclosure will be described with reference to FIGS. 1 to 5.

The additive manufacturing device 1 according to the present embodiment is a device that obtains a three-dimensional molded article by laminating a powder material of metal, ceramic, or the like while melting and curing the powder material by inputting heat to the powder material with a laser. That is, the additive manufacturing device 1 is a device that uses an additive manufacturing method (AM method).

### (Configuration of Additive Manufacturing Device)

As shown in FIG. 1, the additive manufacturing device 1 includes a main part 10, a laser oscillation unit 20, an irradiation unit 30, and a controller 40.

### <Main Part>

The main part 10 includes a housing 11, a movable support unit 12, a stage 13, a base plate 13a, a space 14, and a recoater 14a. The housing 11 is a container in which a space as a build chamber 11a is formed. The build chamber 11a is filled with inert gas such as argon. As an example, the housing 11 has the shape of a rectangular parallelepiped or a cube. A top surface 15 of the housing 11 is provided with a transmission window 16 for transmitting a laser L to be described later.

A bottom surface 17 of the housing 11 is provided with the movable support unit 12. The movable support unit 12 has the shape of a rod protruding upward from the bottom surface 17 of the housing 11, and is configured to be capable of advancing and retreating or expanding and contracting in a direction orthogonal to the bottom surface 17. Although not shown in detail, the movable support unit 12 is configured to be capable of advancing and retreating or expanding and contracting by an actuator.

The stage 13, the base plate 13a, and the space 14 are provided at an upper end of the movable support unit 12. That is, the stage 13, the base plate 13a, and the space 14 can be moved in an up-down direction in accordance with the advance and retreat of the movable support unit 12. The stage 13 has the shape of a plate that spreads in a plane orthogonal to the movable support unit 12. The area of the stage 13 may be appropriately determined depending on the dimensions of a molded article. The space 14 is provided on an upper surface of the stage 13 with the base plate 13a therebetween. The space 14 is a region where the above-described powder material of metal, ceramic, or the like is spread. An upper surface of the space 14 is a surface to be irradiated with the laser L, and is smoothed and flattened. A region of this upper surface where the molded article is to be formed will be referred to as a “build surface 18” hereinafter. The recoater 14a is a unit for filling and laying powder on the build surface 18.

A moving distance of the space 14, which is caused to advance and retreat by the movable support unit 12, is automatically controlled according to the number of times of lamination of the molded article. That is, the movable support unit 12 is configured to move slightly downward to proceed with the molding of a new layer in a case where the molding of one layer is completed on the build surface 18. In other words, the space 14 is moved downward as the molding progresses, but the position of the build surface 18 in the up-down direction is always constant. Such an operation is repeated for a plurality of layers, so that the melted and cured metal or ceramic is laminated and a molded article having a three-dimensional shape is formed.

### (Laser Oscillation Unit)

The laser oscillation unit 20 generates (oscillates) the laser L for inputting heat to the powder material. For example, a YAG laser, a fiber laser, a semiconductor laser, or the like is suitably used as the laser L. The type of the laser L may be appropriately determined depending on the amount of heat input required for processing or the dimensions of a molded article. Further, as will be described in detail later, the output of the laser L generated by the laser oscillation unit 20 can be adjusted in accordance with a command from the controller 40. Furthermore, only one laser oscillation unit 20 is provided in the present embodiment.

### (Irradiation Unit)

The irradiation unit 30 is provided on an optical path of the laser L generated by the laser oscillation unit 20. The irradiation unit 30 can change the optical path so that the laser L is emitted toward the build surface 18, and can change an irradiation angle of the laser L with respect to the build surface 18. Specifically, a galvano scanner is used as the irradiation unit 30. The galvano scanner includes a mirror 31 of which an angle can be changed. In a case where the angle of the mirror 31 is changed, the irradiation direction of the laser L reflected by the mirror 31 is changed. That is, the irradiation angle of the laser L with respect to the build surface 18 is changed each time. Further, the irradiation unit 30 also has a function to adjust the speed of the laser.

The “irradiation angle” mentioned here is an angle θ between the irradiation direction of the laser L and a normal direction of the build surface 18 as shown in FIG. 2. More specifically, the irradiation angle includes θx, which is a component based on an X-axis, and θy, which is a component based on a Y-axis, in a case where a coordinate system of the X-axis and the Y-axis is set on the build surface 18. Therefore, in a case where a beam diameter in a state where the irradiation angle is zero is denoted by D₀ (that is, Dx=Dy), an irradiation area D_{θ} of the laser L at a position corresponding to the irradiation angle θ is expressed as an area of an ellipse having Dx cos θx and Dy cos θy as a major axis or a minor axis as in Equation (1).

$${D}_{θ} = π / 4 \times Dx cos θ x \times Dy Cos θ y \qquad ( 1 )$$

Further, energy density Q₀ in this case is expressed as in Equation (2) with an output P₀ of the laser L, which is obtained in a state where the irradiation angle is zero, as a reference.

$${Q}_{θ} = {P}_{0} / ( π DxDy / 4 ) \qquad ( 2 )$$

A change in the irradiation angle (that is, the angle of the mirror 31) by the irradiation unit 30 is controlled by the controller 40 to be described later. The build surface 18 is scanned with the laser L along a predetermined path. The path of the laser L is appropriately determined depending on the shape of the molded article. Further, information on the irradiation angle of the laser L by the irradiation unit 30 is sent to the controller 40 (to be described later) as an electric signal.

### (Controller)

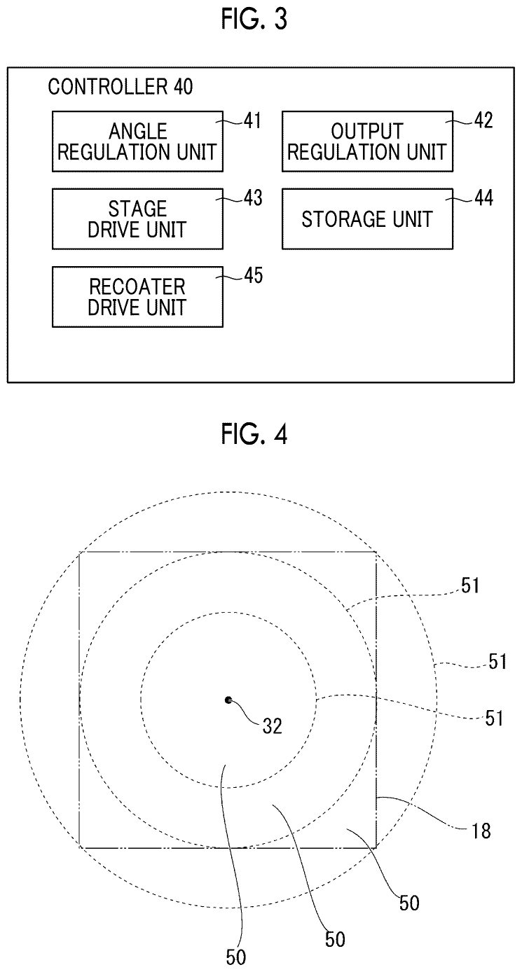

The controller 40 controls the operation of the laser oscillation unit 20 and the irradiation unit 30 described above. Specifically, as shown in FIG. 3, the controller 40 includes an angle adjustment unit 41, an output adjustment unit 42, a stage drive unit 43, a storage unit 44, and a recoater drive unit 45.

The angle adjustment unit 41 changes the angle (posture) of the mirror 31 of the irradiation unit 30 described above to adjust the irradiation angle of the laser L with respect to the build surface 18. That is, the build surface 18 is scanned with the laser L based on a signal sent from the angle adjustment unit 41. This scanning path is set in advance based on the shape and dimensions of the molded article. The output adjustment unit 42 controls the output of the laser L generated by the laser oscillation unit 20. Specifically, the output of the laser L is appropriately determined based on the irradiation area described above.

Here, a beam diameter is changed according to the irradiation angle as in Equation (1). Accordingly, in a case where the output P₀ of the laser L is set to be constant, the energy density fluctuates according to the irradiation angle as in Equation (2). Therefore, the output adjustment unit 42 adjusts an output P_{xy} of the laser L at an arbitrary position (x, y) on the build surface 18 based on Equation (3) described below.

$${P}_{xy} = {P}_{0} \times π / 4 \times Dx cos θ x \times Dy cos θ y / ( π {D}_{0}^{2} / 4 ) \qquad ( 3 )$$

That is, an output at an arbitrary position is determined based on an irradiation area obtained from the irradiation angle. Therefore, even at a position where the irradiation angle is greater than zero, the energy density of the laser L is maintained to be the same as the energy density in a case where the irradiation angle is zero.

Further, the output adjustment unit 42 is configured to divide the build surface 18 into a plurality of sections 50 according to a range of the irradiation angle of the laser L and to adjust the output of the laser L for each section 50. Specifically, as shown in FIG. 4, the build surface 18 is divided into a plurality of sections 50 by dividing lines 51 having the shape of concentric circles centered on an irradiation point 32 of the laser L emitted from the irradiation unit 30. In the example shown in FIG. 4, the number of the sections 50 is three. Furthermore, the diameter of each of the concentric circles may be appropriately determined based on the shape or the like of the molded article. That is, the concentric circles may be concentric circles arranged at regular intervals or concentric circles arranged at irregular intervals. The irradiation angle is increased from the section 50 provided on an inner peripheral side toward the section 50 provided on an outer peripheral side. The entire build surface 18 is covered with the sections 50.

The stage drive unit 43 generates drive signals for causing the stage 13 and the space 14 to advance and retreat. A drive signal is transmitted to lower the space 14 by one pitch whenever the molding of one layer on the build surface 18 is completed. The one pitch is a predetermined lamination height per layer of the molded article. As the pitch is smaller, the surface roughness of the molded article can be lowered. Information on the pitch, and the like are temporarily or permanently stored in the storage unit 44. The recoater drive unit 45 transmits a drive signal for supplying a new powder material onto the build surface 18 to the recoater 14a whenever the molding of one layer on the build surface 18 is completed.

### (Additive Manufacturing Method and Control Flow of Controller 40)

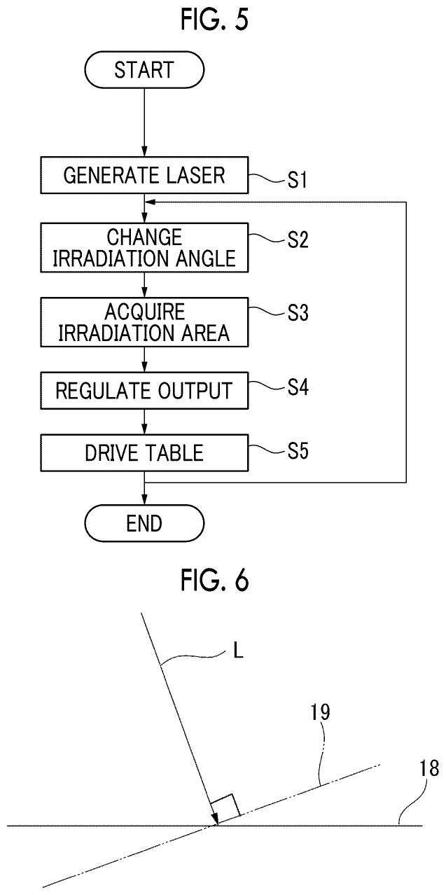

Next, the additive manufacturing method according to the first embodiment of the present disclosure will be described with reference to FIG. 5. Further, this method is also established as a control flow of the controller 40.

As shown in FIG. 5, this method and the control flow include Step S1 of generating the laser L, Step S2 of changing the irradiation angle, Step S3 of acquiring the irradiation area, Step S4 of adjusting the output of the laser L, and Step S5 of driving a table.

In Step S1, the laser oscillation unit 20 generates the laser L. The output of the laser L in an initial state is set in advance by the output adjustment unit 42 of the controller 40. Next, in Step S2, the angle adjustment unit 41 changes the irradiation direction of the laser L, that is, the irradiation angle according to a path based on the shape of the molded article. Information on the irradiation angle at this time is stored in the storage unit 44. Next, in Step S3, the output adjustment unit 42 acquires the irradiation area of the laser L based on the irradiation angle. The irradiation area is obtained from Equation (1) described above.

Further, in Step S4, the output adjustment unit 42 acquires the output of the laser L from Equation (2) based on the irradiation area, and sends a command signal to the laser oscillation unit 20. Accordingly, the output of the laser L is adjusted according to the irradiation angle. At this time, in a case where the build surface 18 is divided into the plurality of sections 50 as described above, the output adjustment unit 42 changes the output of the laser L for each section 50. That is, the output of the laser L is constant in one section 50. Then, in Step S5, the stage drive unit 43 lowers the table and the space 14 after the molding of one layer is completed. At this time, the recoater 14a is operated by the recoater drive unit 45 to supply a new powder material to the space 14. Steps S2 to S5 are repeatedly executed for a plurality of layers, so that a molded article is formed. As described above, all steps related to the additive manufacturing method according to the present embodiment and the control flow of the controller 40 are completed.

### Effects

Here, in a case where three-dimensional laminate molding is performed, the amount of heat input to not only an end portion of the path to be scanned with the laser L but also the entire path affects the quality of the molded article. For this reason, there has been an increasing demand for a technique capable of setting appropriate energy density over the entire path that is scanned with the laser L. Therefore, each of configurations and the method described above are adopted in the present embodiment.

According to the above-described configuration, the output adjustment unit 42 adjusts the output of the laser L based on the irradiation area of the laser L on the build surface 18. Accordingly, even in a case where the fluctuation of the irradiation area occurs due to a change in the irradiation angle, a change in a path length (focal length) of the beam, or the like, the output of the laser L is adjusted such that energy density can always be maintained in an appropriate state by following the fluctuation. As an example, the output of the laser L is adjusted such that energy density takes a constant value. (Here, the “constant” mentioned here refers to substantially constant, and slight fluctuation caused by disturbance factors or the like is allowed.) Therefore, since the fluctuation of the energy density is suppressed even in a case where the irradiation area fluctuates regardless of the shape of the molded article, the amount of heat input to the powder material on the build surface 18 can be kept constant. As a result, the quality of the molded article can be further improved. On the contrary, in a case where the amount of heat input is unstable, the wall thickness and dimensional accuracy of the molded article are affected. As a result, there is a possibility that the yield of a final product may decrease. According to the above-described configuration, it is possible to greatly reduce such a possibility.

Further, in a case where an output and an irradiation area of the laser L in a state where the irradiation angle is zero are denoted by P₀ and D₀, respectively, and an output and an irradiation area of the laser L in a state where the irradiation angle is 0 are denoted by P₀ and D₀, respectively, in the above-described configuration, the output adjustment unit 42 determines an output of the laser L at an arbitrary position (x, y) as in Equation (3) described below.

$${P}_{xy} = {P}_{0} \times π / 4 \times Dx cos θ x \times Dy cos θ y / ( π {D}_{0}^{2} / 4 ) \qquad ( 3 )$$

According to this configuration, the output and the irradiation area of the laser L in a state where the irradiation angle is θ are adjusted based on the output and the irradiation area of the laser L in a state where the irradiation angle is zero. Accordingly, the amount of heat input equivalent to the amount of heat input to the powder material in a state where the irradiation angle is zero can be maintained even at a position where the irradiation area has fluctuated on the build surface 18 due to the fluctuation of the irradiation angle. As a result, the quality of the molded article can be further improved.

Further, the output adjustment unit 42 divides the build surface 18 into a plurality of sections 50 using dividing lines 51 having the shape of concentric circles centered on the irradiation point 32 of the laser L. Furthermore, the output adjustment unit 42 can set the output of the laser L different for each section 50. Here, since the output of the laser L is unstable at a boundary between the sections in a case where the energy density of the laser L is changed, a slight fluctuation component may occur with respect to a predetermined value. According to the above-described configuration, the build surface 18 is divided into the shape of concentric circles centered on the irradiation point 32 of the laser L. Accordingly, the number of such boundaries where the output is changed can be reduced. Therefore, since the number of positions where the output of the laser L is unstable is reduced, the quality of the molded article can be further improved.

The first embodiment of the present disclosure has been described above. The configuration and the method described above can have various modifications without departing from the scope of the present disclosure.

### Second Embodiment

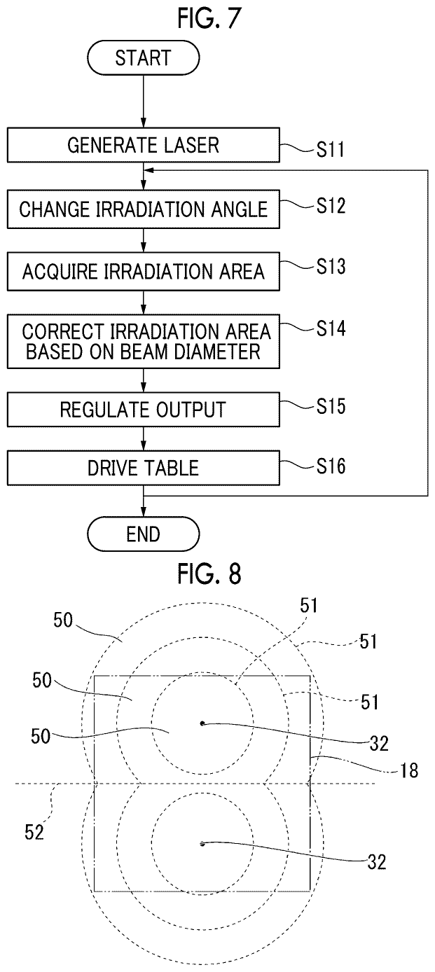

Next, a second embodiment of the present disclosure will be described with reference to FIGS. 6 and 7. The same components as those of the first embodiment will be denoted by the same reference numerals, and detailed description thereof will be omitted.

The present embodiment is different from the first embodiment in that the output adjustment unit 42 acquires an irradiation area of the laser L and then corrects a value of the irradiation area using a beam diameter acquired in advance. The “beam diameter” mentioned here refers to the diameter of the laser L on a measurement surface 19 that is a surface orthogonal to the irradiation direction (traveling direction) of the laser L as shown in FIG. 6.

In order to obtain a value of such a beam diameter, a beam profiler of which the posture can be freely changed toward the irradiation direction of the laser L at each position on the build surface 18 is suitably used. In particular, in a region close to the edge of the build surface 18, the diameter of the laser L on the build surface 18 may have a distribution different from a Gaussian distribution due to a change in the angle of the mirror 31 to change the irradiation direction of the laser L or an increase in the path length (focal length) of the beam. In a case where there is an error in the beam diameter, the value of the irradiation area is also affected and a deviation occurs in the final output of the laser L. For this reason, it is important to actually measure the beam diameter on the measurement surface 19. It is desirable that the beam diameter is measured using the beam profiler in advance before molding work. The output adjustment unit 42 determines the final output of the laser L based on the value of the irradiation area corrected as described above.

A control flow of the controller 40 in a case where the above-described correction is performed is as shown in FIG. 7. First, in Step S11, the laser oscillation unit 20 generates (oscillates) the laser L. Next, in Step S12, the angle adjustment unit 41 changes the irradiation direction of the laser L, that is, the irradiation angle according to a path based on the shape of the molded article. Information on the irradiation angle at this time is stored in the storage unit 44. Next, in Step S13, the output adjustment unit 42 acquires the irradiation area of the laser L based on the irradiation angle. The irradiation area is obtained from Equation (1) described above.

Further, in Step S14, the output adjustment unit 42 corrects a value of the irradiation area based on the beam diameter described above. In subsequent Step S15, the output adjustment unit 42 acquires the output of the laser L from Equation (3) based on the corrected irradiation area, and sends a command signal to the laser oscillation unit 20. Accordingly, the output of the laser L is adjusted according to the irradiation angle. At this time, in a case where the build surface 18 is divided into the plurality of sections 50 as described above, the output adjustment unit 42 changes the output of the laser L for each section 50. That is, the output of the laser L is constant in one section 50. Then, in Step S16, the stage drive unit lowers the stage and the space 14 after the molding of one layer is completed. Steps S12 to S16 are repeatedly executed for a plurality of layers, so that a molded article is formed. As described above, all steps related to the additive manufacturing method according to the present embodiment and the control flow of the controller 40 are completed.

### Effects

In the above-described configuration, the output adjustment unit 42 corrects the value of the irradiation area based on the beam diameter on the measurement surface 19 orthogonal to the laser L at an arbitrary position on the build surface 18 acquired in advance. Then, the output of the laser L is adjusted based on the corrected value of the irradiation area.

Here, since the path length (focal length) of the laser L is changed depending on a position on the build surface 18, the beam diameter of the laser L (the profile of the laser L) may fluctuate. In particular, in a region close to the edge of the build surface 18, the diameter of the laser L on the build surface 18 may have a distribution different from a Gaussian distribution due to an increase in the path length (focal length) of the beam. In a case where there is an error in the beam diameter, the value of the irradiation area is also affected and a deviation occurs in the final output of the laser L. According to the above-described configuration, a beam diameter is acquired in advance at each position and then the value of the irradiation area is corrected. Accordingly, molding using the laser L can progress in a state where more appropriate energy density is maintained based on an actual beam diameter. Therefore, it is possible to further improve the yield of a final product.

### Other Embodiments

The respective embodiments of the present disclosure have been described above. The configuration described above can have various modifications and improvements without departing from the scope of the present disclosure.

For example, an example in which only one movable support unit 12 of the main part 10 is provided has been described in the first embodiment. However, the number of movable support units 12 may be appropriately determined depending on a design or specifications, and may be two or more. As the number of movable support units 12 is larger, the table and the space 14 can be more stably supported from below. For this reason, the horizontal state of the build surface 18 can be more accurately maintained, so that the dimensional accuracy of a molded article can be further improved.

Further, an example in which only one laser L is emitted from the irradiation unit 30 has been described in each of the above-described embodiments. However, the number of irradiation points 32 of lasers L emitted from the irradiation unit 30 is not limited to one, and may be two or more. Specifically, in a case where there are two irradiation points 32 as shown in FIG. 8 as a first modification example, the above-described output adjustment unit 42 can divide the build surface 18 into the sections 50 for each irradiation point 32. That is, it is desirable to divide the build surface 18 using a linear dividing line 52 at a central portion between the irradiation points 32 while forming a plurality of concentric circular sections 50 with each irradiation point 32 as a reference. Accordingly, it is possible to proceed with molding work without interference between the lasers L emitted from the respective irradiation points 32.

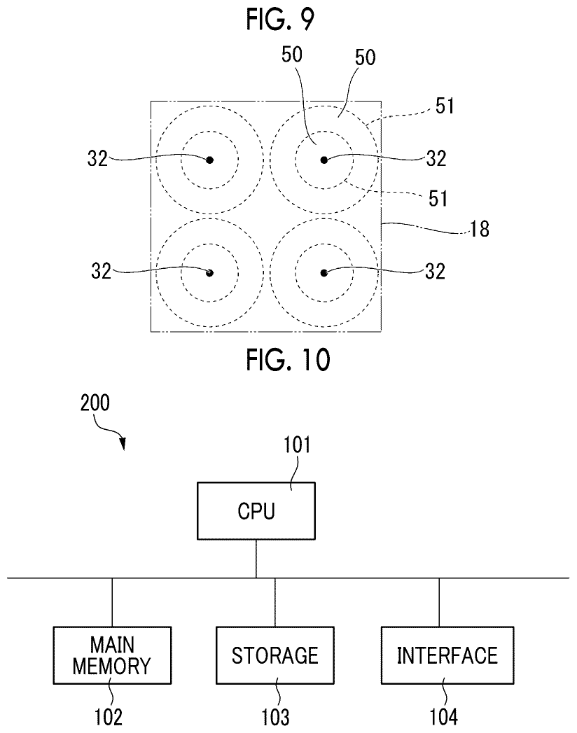

Furthermore, in a case where four irradiation points 32 are arranged in a grid pattern as shown in FIG. 9 as a second modification example, the entire build surface 18 can be covered with concentric circular sections 50 centered on the respective irradiation points 32. Even in this case, it is possible to proceed with molding work without interference between the lasers L emitted from the respective irradiation points 32.

In addition, an example in which the output adjustment unit 42 acquires the irradiation area based on the irradiation angle of the laser L has been described in each of the above-described embodiments. However, the irradiation area of the laser L does not necessarily have to be acquired by the output adjustment unit 42. As another example, a device that acquires an irradiation area at any time may be provided on the top surface 15 of the housing 11, and may be configured to transmit the irradiation area to the output adjustment unit 42.

Specifically, a device that uses image analysis using a thermographic image is conceivable as such a device in addition to an imaging device, such as a CCD camera or a CMOS camera. According to this configuration, the output of the laser L is determined based on the value of an accurate irradiation area that is actually measured or acquired. Accordingly, it is possible to further improve the dimensional accuracy or the accuracy of the shape of a molded article. Therefore, it is possible to further improve the yield of a final product.

Further, the number of divisions of the build surface 18, that is, the number of the sections 50 divided by the output adjustment unit 42, which has been described in each of the above-described embodiments, is merely an example, and may be appropriately determined depending on the dimensions or the shape of a molded article. That is, the number of the sections 50 may be three or more or two or less. As the number of the sections 50 is reduced, the number of boundaries at which the output of the laser L is unstable can be reduced. On the other hand, in a case where the number of the sections 50 is increased, the output of the laser L is finely changed by that amount. Accordingly, the quality of a final product can be improved. Furthermore, it is also possible to adopt a configuration in which such sections 50 are not provided and the output of the laser L is changed steplessly according to the fluctuation of the irradiation area.

In a processing flow of the controller 40 of the embodiment of the present disclosure, the order of processing may be changed in a range in which appropriate processing is performed.

Each of the storage unit 44 and other storage devices of the embodiment of the present disclosure may be provided anywhere in a range in which appropriate information is transmitted and received. Further, each of a plurality of storage unit 44 and other storage devices may be present in a range in which appropriate information is transmitted and received, and may store data in a distribution manner.

The process of the processing performed by the above-described controller 40 is stored in the form of a program in a recording medium that can be read by a computer 200, and the computer 200 reads out and executes this program, so that the processing is performed. A specific example of the computer 200 will be described below.

As shown in FIG. 10, the computer 200 includes a CPU 101, a main memory 102, a storage 103, and an interface 104.

For example, the controller 40 described above is mounted on the computer 200. Further, the operation of each processing unit described above is stored in the storage 103 in the form of a program. The CPU 101 reads out the program from the storage 103, loads the program into the main memory 102, and performs the above-described processing according to the program. Further, the CPU 101 secures a storage area corresponding to the above-described storage unit 44 in the main memory 102 according to the program.

Examples of the storage 103 include a hard disk drive (HDD), a solid-state drive (SSD), a magnetic disk, a magneto-optical disk, a compact disc read-only memory (CD-ROM), a digital versatile disc read-only memory (DVD-ROM), and a semiconductor memory. The storage 103 may be an internal medium directly connected to a bus of the computer 200 or may be an external medium connected to the computer 200 via the interface 104 or a communication line. Further, in a case where this program is delivered to the computer 200 through the communication line, the computer 200 to which the program is delivered may load the program into the main memory 102 and may perform the processing. The storage 103 is a non-transitory tangible storage medium.

Further, the program may realize a part of the above-described functions. Furthermore, the program may be a so-called differential file (differential program) that can realize the above-described functions in combination with a program already recorded in the computer 200.

A custom large scale integrated circuit (LSI) such as a programmable logic device (PLD), an application specific integrated circuit (ASIC), a graphics processing unit (GPU), and a processing device similar thereto may be provided in addition to the above-described configuration or instead of the above-described configuration. Examples of the PLD include a programmable array logic (PAL), a generic array logic (GAL), a complex programmable logic device (CPLD), and a field programmable gate array (FPGA). In this case, some or all of functions to be realized by a processor may be realized by the integrated circuit.

### Supplementary Notes

The additive manufacturing device 1 and the additive manufacturing method described in each embodiment are understood as follows, for example.
(1) An additive manufacturing device 1 according to a first aspect is an additive manufacturing device 1 that supplies a powder material to a build surface 18 of a molded article and performs laminate molding of the molded article by irradiating the supplied powder material with a laser L to melt and cure the powder material. The additive manufacturing device 1 includes a main part 10 that includes a stage 13 supporting the molded article, a laser oscillation unit 20 that generates the laser L, an irradiation unit 30 that can irradiate the build surface 18 with the laser L and change an irradiation angle of the laser L with respect to the build surface 18, and an output adjustment unit 42 that can adjust an output of the laser L based on an irradiation area of the laser L on the build surface 18.

According to the above-described configuration, the output adjustment unit 42 adjusts the output of the laser L based on the irradiation area of the laser L on the build surface 18. Accordingly, even in a case where the fluctuation of the irradiation area occurs due to a change in the irradiation angle, irregularities on the build surface 18, or the like, it is possible to perform molding using the laser L while always maintaining energy density in an appropriate state by following the fluctuation.
(2) An additive manufacturing device 1 according to a second aspect is the additive manufacturing device 1 of (1) in which the output adjustment unit 42 determines an output P_{xy} of the laser L at an arbitrary position (x, y) as in Equation (3) in a case where the output and the irradiation area of the laser L in a state where the irradiation angle is zero are denoted by P₀ and D₀, respectively.

$${P}_{xy} = {P}_{0} \times π / 4 \times Dx cos θ x \times Dy cos θ y / ( π {D}_{0}^{2} / 4 ) \qquad ( 3 )$$

According to the above-described configuration, an output and an irradiation area of the laser L in a state where the irradiation angle is 0 are adjusted based on the output and the irradiation area of the laser L in a state where the irradiation angle is zero. Accordingly, the amount of heat input to the powder material in a state where the irradiation angle is zero can be maintained even at a position where the irradiation area has fluctuated on the build surface 18.
(3) An additive manufacturing device 1 according to a third aspect is the additive manufacturing device 1 of (1) or (2) in which the output adjustment unit 42 adjusts the output of the laser L based on a beam diameter on a measurement surface 19 orthogonal to the laser L at an arbitrary position on the build surface 18 acquired in advance.

Here, since the path length of the laser L is changed depending on a position on the build surface 18, the beam diameter of the laser L (the profile of the laser L) may fluctuate. According to the above-described configuration, a beam diameter is acquired in advance at each position and then the value of the irradiation area is corrected. Accordingly, molding using the laser L can progress in a state where more appropriate energy density is maintained.
(4) An additive manufacturing device 1 according to a fourth aspect is the additive manufacturing device 1 according to any one of (1) to (3) in which the output adjustment unit 42 can divide the build surface 18 into a plurality of sections 50 using dividing lines 51 having a shape of concentric circles centered on an irradiation point 32 of the laser L and set the output of the laser L different for each section 50.

Here, in a case where the energy density of the laser L is changed, the output of the laser L may be unstable at a boundary between the sections. According to the above-described configuration, the build surface 18 is divided into the shape of concentric circles centered on the irradiation point 32 of the laser L. Accordingly, the number of such boundaries can be reduced. Therefore, since the number of positions where the output of the laser Lis unstable is reduced, the quality of the molded article can be further improved.
(5) An additive manufacturing device 1 according to a fifth aspect is the additive manufacturing device 1 of (4) further including a plurality of the irradiation units 30, in which the output adjustment unit 42 sets the plurality of sections 50 for each irradiation unit 30.

According to the above-described configuration, even in a case where there are a plurality of the irradiation units 30, a plurality of concentric circular sections 50 can be formed for each irradiation unit 30. Accordingly, the instability of an output of the laser at the boundary where energy density is changed is suppressed, so that a more excellent molded article can be obtained.
(6) An additive manufacturing method according to a sixth aspect is an additive manufacturing method of generating a molded article by irradiating a powder material with a laser L to melt and cure the powder material. The method includes a step of generating the laser L, a step of irradiating a build surface 18 on which the powder material is laid with the laser L and changing an irradiation angle of the laser L with respect to the build surface 18, a step of acquiring an irradiation area of the laser L on the build surface 18, and a step of adjusting an output of the laser L based on the irradiation area.

According to the above-described method, the output of the laser L is adjusted in the step of adjusting the output of the laser L based on the irradiation area of the laser L on the build surface 18. Accordingly, even in a case where the fluctuation of the irradiation area occurs due to a change in the irradiation angle, irregularities on the build surface 18, or the like, it is possible to perform molding using the laser L while always maintaining energy density in an appropriate state by following the fluctuation.
(7) An additive manufacturing method according to a seventh aspect is the additive manufacturing method of (6) in which, in the step of adjusting the energy density, an output P_{xy} of the laser L at an arbitrary position (x, y) is determined as in Equation (3) in a case where the output and the irradiation area of the laser L in a state where the irradiation angle is zero are denoted by P₀ and D₀, respectively.

$${P}_{xy} = {P}_{0} \times π / 4 \times Dx cos θ x \times Dy cos θ y / ( π {D}_{0}^{2} / 4 ) \qquad ( 3 )$$

According to the above-described method, an output in a state where the irradiation angle is θ is adjusted based on the output and the irradiation area of the laser L in a state where the irradiation angle is zero. Accordingly, the amount of heat input to the powder material in a state where the irradiation angle is zero can be maintained even at a position where the irradiation area has fluctuated on the build surface 18.
(8) An additive manufacturing method according to an eighth aspect is the additive manufacturing method of (6) or (7) in which, in the step of adjusting the output of the laser L, the output of the laser L is adjusted based on a beam diameter on a measurement surface 19 orthogonal to the laser L at an arbitrary position on the build surface 18 acquired in advance.

Here, since the path length of the laser L is changed depending on a position on the build surface 18, the beam diameter of the laser L (the profile of the laser L) may fluctuate. According to the above-described method, the beam diameter is acquired in advance at each position and then the value of the irradiation area is corrected. Accordingly, molding using the laser L can progress in a state where more appropriate energy density is maintained.
(9) An additive manufacturing method according to a ninth aspect is the additive manufacturing method according to any one of (6) to (8) in which, in the step of adjusting the output of the laser L, the build surface 18 is divided into a plurality of sections 50 by dividing lines 51 having a shape of concentric circles centered on an irradiation point 32 of the laser L and the output of the laser L different for each section 50 is set.

Here, in a case where the energy density of the laser L is changed, the output of the laser L may be unstable at a boundary between the sections. According to the above-described method, the build surface 18 is divided into the shape of concentric circles centered on the irradiation point 32 of the laser L. Accordingly, the number of such boundaries can be reduced. Therefore, since the number of positions where the output of the laser is unstable is reduced, the quality of a molded article can be further improved.
(10) An additive manufacturing method according to a tenth aspect is the additive manufacturing method of (9) in which the laser L is emitted from each of the plurality of irradiation points 32 and the plurality of sections 50 are set for each laser L in the step of adjusting the output of the laser L.

According to the above-described configuration, even in a case where there are a plurality of the irradiation units 30, a plurality of concentric circular sections 50 can be formed for each irradiation unit 30. Accordingly, the instability of an output of the laser at the boundary where energy density is changed is suppressed, so that a more excellent molded article can be obtained.

### INDUSTRIAL APPLICABILITY

According to the present disclosure, it is possible to provide an additive manufacturing device and an additive manufacturing method in which the energy density of a laser with which a molded article is irradiated can be appropriately maintained.

### REFERENCE SIGNS LIST

1: additive manufacturing device
10: main part
11: housing
11a: build chamber
12: movable support unit
13: stage
13a: base plate
14: space
14a: recoater
15: top surface
16: transmission window
17: bottom surface
18: build surface
19: measurement surface
20: laser oscillation unit
30: irradiation unit
31: mirror
32: irradiation point
40: controller
41: angle adjustment unit
42: output adjustment unit
43: stage drive unit
44: storage unit
45: recoater drive unit
50: section
51, 52: dividing line
101: CPU
102: main memory
103: storage
104: interface
200: computer
L: laser

1. An additive manufacturing device that supplies a powder material to a build surface of a molded article and performs laminate molding of the molded article by irradiating the supplied powder material with a laser to melt and cure the powder material, the additive manufacturing device comprising:
a main part that includes a stage supporting the molded article;
a laser oscillation unit that generates the laser;
an irradiation unit that is capable of irradiating the build surface with the laser and changing an irradiation angle of the laser with respect to the build surface; and
an output adjustment unit that is capable of adjusting an output of the laser based on an irradiation area of the laser on the build surface, wherein
the output adjustment unit is capable of dividing the build surface into a plurality of sections using dividing lines having a shape of concentric circles centered on an irradiation point of the laser and setting the output of the laser different for each section.

2. The additive manufacturing device according to claim 1,
wherein the output adjustment unit determines an output P_{xy} of the laser at an arbitrary position (x, y) as in the following equation in a case where the output and the irradiation area of the laser in a state where the irradiation angle is zero are denoted by P₀ and D₀, respectively,
$${P}_{xy} = {P}_{0} \times π / 4 \times Dx cos θ x \times Dy cos θ y / ( π {D}_{0}^{2} / 4 ) .$$

3. The additive manufacturing device according to claim 1,
wherein the output adjustment unit adjusts the output of the laser based on a beam diameter on a measurement surface orthogonal to the laser at an arbitrary position on the build surface acquired in advance.

4. (canceled)

5. The additive manufacturing device according to claim 1, further comprising:
a plurality of the irradiation units,
wherein the output adjustment unit sets the plurality of sections for each irradiation unit.

6. An additive manufacturing method of generating a molded article by irradiating a powder material with a laser to melt and cure the powder material, the method comprising:
a step of generating the laser;
a step of irradiating a build surface on which the powder material is laid with the laser and changing an irradiation angle of the laser with respect to the build surface;
a step of acquiring an irradiation area of the laser on the build surface; and
a step of adjusting an output of the laser based on the irradiation area.

7. The additive manufacturing method according to claim 6,
wherein, in the step of adjusting the output of the laser, an output P_{xy} of the laser at an arbitrary position (x, y) is determined as in the following equation in a case where the output and the irradiation area of the laser in a state where the irradiation angle is zero are denoted by P₀ and D₀, respectively,
$${P}_{xy} = {P}_{0} \times π / 4 \times Dx cos θ x \times Dy cos θ y / ( π {D}_{0}^{2} / 4 ) .$$

8. The additive manufacturing method according to claim 6,
wherein, in the step of adjusting the output of the laser, the output of the laser is adjusted based on a beam diameter on a measurement surface orthogonal to the laser at an arbitrary position on the build surface acquired in advance.

9. The additive manufacturing method according to claim 6,
wherein, in the step of adjusting the output of the laser, the build surface is divided into a plurality of sections by dividing lines having a shape of concentric circles centered on an irradiation point of the laser and the output of the laser different for each section is set.

10. The additive manufacturing method according to claim 9,
wherein the laser is emitted from each of the plurality of irradiation points, and
the plurality of sections are set for each laser in the step of adjusting the output of the laser.
